(19) United States
(12) Patent Application Publication
(10) Pub. No.: US 2026/0287510 A1
(43) Pub. Date: Sep. 24, 2026

(54) NANOSTRUCTURED SENSING SUBSTRATES, CHIPS AND METHODS OF FABRICATION

(71) Applicant: North Carolina Agricultural and Technical State University, Greensboro, NC (US)

(72) Inventors: Farbod Ebrahimi, Greensboro, NC (US); Kristen Dellinger, Greensboro, NC (US); Anjali Kumari, Arden, NC (US)

(21) Appl. No.: 19/572,034

(22) Filed: Mar. 19, 2026

Related U.S. Application Data
(60) Provisional application No. 63/774,247, filed on Mar. 19, 2025.

(51) Int. Cl. G01N 21/65; B82Y 30/00; B82Y 40/00

(52) U.S. Cl. CPC G01N 21/658; B82Y 30/00; B82Y 40/00

(57) ABSTRACT

A nanostructured substrate for spectroscopic analysis is provided which includes a substrate base layer having at least a first surface, a hydrophobic coating disposed over at least the first surface of the substrate base layer, and a metallic nanostructure layer disposed over at least a portion of the hydrophobic coating. The metallic nanostructure layer has a nominal thickness from about 3 nanometers to about 15 nanometers and includes a plurality of metallic nanostructures deposited at quasi-periodic intervals and separated by gaps, the metallic nanostructures having an average diameter from about 10 nanometers to about 100 nanometers. A surface including the nanostructured substrate and a method for making the substrate are also provided.

### CROSS REFERENCE TO RELATED APPLICATIONS

This application claims the benefit of U.S. Provisional Application Ser. No. 63/774,247, filed Mar. 19, 2025, the entire contents of which is incorporated by reference herein.

### STATEMENT AS TO RIGHTS TO INVENTIONS MADE UNDER FEDERALLY SPONSORED RESEARCH OR DEVELOPMENT

This invention was made with government support under Grant No. GM149496 awarded by the National Institutes of Health. The government has certain rights in the invention.

### FIELD

The present invention relates generally to substrates for optical and/or electrochemical analysis of analytes and more particularly to nanostructured substrates for molecular and/or particulate analysis using techniques such as surface-enhanced Raman spectroscopy (SERS), to surfaces including such substrates, and to methods for making such substrates.

### BACKGROUND

The urgent need of analytical and diagnostic technologies, for analysis of analytes present in low concentrations less than InM, has created an urgent need for ultrasensitive detection methods capable of identifying biomarkers, pathogens, contaminants, and other molecules and or particulates from systems such as but not limited to the human body and the environment. This growing technological push demands detection systems that can achieve high signal-to-noise ratios while maintaining practical feasibility for widespread implementation. Current detection methods face significant limitations in sensitivity, cost, and operational complexity.

In particular, there is a need for improved, yet inexpensive, substrates for testing of analytes. Paper-based substrates are inexpensive but typically must be modified to provide satisfactory performance. Chemical modification methods struggle with achieving uniform and reproducible results. Thermal modification of paper-based substrate often leads to structural degradation of the substrate.

Thus, there remains a need for improved paper-based substrates for spectroscopic analysis such as surface-enhanced Raman spectroscopy (SERS), for chips including such substrates, and for methods for making such substrates.

### SUMMARY

In regard to the foregoing needs, the present invention provides a nanostructured substrate for spectroscopic analysis, as well as chips incorporating the nanostructured substrate. The present disclosure also provides methods for making a nanostructured substrate.

In a first aspect, the present disclosure provides a nanostructured substrate for optical and/or electrochemical analysis. The nanostructured substrate includes a substrate base layer having at least a first surface, a hydrophobic coating disposed over at least the first surface of the substrate base layer, and a metallic nanostructure layer disposed over at least a portion of the hydrophobic coating. The metallic nanostructure layer has a nominal thickness from about 3 nanometers to about 15 nanometers and includes a plurality of metallic nanostructures deposited at quasi-periodic intervals and separated by gaps, the metallic nanostructures having an average diameter from about 10 nanometers to about 100 nanometers.

In some embodiments, the substrate base layer includes a material selected from the group consisting of cellulosic web, glass, silica, quartz, polymers, mica, and metal. Preferably, the substrate base layer includes a cellulosic paper web.

In some embodiments, the hydrophobic coating includes a least one hydrophobic agent selected from the group consisting of substituted or unsubstituted organosilanes, substituted or unsubstituted fluorosilanes, substituted or unsubstituted chlorosilanes, fatty acids, waxes, self-assembled monolayer-forming agents, and combinations thereof.

In some embodiments, the metallic nanostructure layer includes a metal selected from the group consisting of silver, gold, titanium, iron, chromium, nickel, aluminum, platinum, copper, and mixtures thereof. Preferably, the metallic nanostructure layer includes silver.

In a second aspect, the present disclosure provides a surface for chemical analysis. The surface includes a polymer enclosure; at least one sample well, disposed within the polymer enclosure; and a nanostructured substrate, as described above, disposed within the polymer enclosure.

In some embodiments, the surface is adapted for use in at least one analytical technique selected from the group consisting of surface-enhanced Raman spectroscopy (SERS), localized surface plasmon resonance (LSPR), surface-enhanced infrared absorption spectroscopy (SEIRAS), electrochemical sensing, fluorescence-based detection, and colorimetric detection.

In a further aspect, the present disclosure provides a method for making a nanostructured substrate for optical and/or electrochemical analysis. The method includes the steps of providing an substrate base layer having at least a first surface, forming a hydrophobic coating disposed over at least the first surface of the substrate base layer, and forming a metallic nanostructure layer by vapor deposition, disposed over at least a portion of the hydrophobic coating. The metallic nanostructure layer has a nominal thickness from about 3 nanometers to about 15 nanometers and includes a plurality of metallic nanostructures deposited at quasi-periodic intervals and separated by gaps, the metallic nanostructures having an average diameter from about 10 nanometers to about 100 nanometers.

In still another aspect, the present disclosure provides an antimicrobial material which includes an substrate base layer having at least a first surface, a hydrophobic coating disposed over at least the first surface of the substrate base layer, and a metallic nanostructure layer disposed over at least a portion of the hydrophobic coating wherein the metallic nanostructure layer imparts antimicrobial activity to the substrate.

These and other aspects of the invention are set forth in more detail in the description of the invention below.

### BRIEF DESCRIPTION OF THE DRAWINGS

FIG. 1 is a schematic diagram of a nanostructured substrate according to an embodiment of the present disclosure.

FIG. 2 is a perspective view of a surface for chemical analysis according to an embodiment of the present disclosure.

FIGS. 3A-3F are scanning electron micrographs of nanostructured substrates according to embodiments of the present invention, and FIG. 3G is a scanning electron micrograph of a control.

FIGS. 4A-4E are atomic force micrographs of nanostructured substrates according to embodiments of the present invention, and FIG. 4F is a scanning electron micrograph of a control.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein.

All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps and those that do not materially affect the basic and novel characteristic(s) of the claimed invention. Thus, the term “consisting essentially of” as used herein should not be interpreted as equivalent to “comprising.”

It will also be understood that, as used herein, the terms “example,” “exemplary,” and grammatical variations thereof are intended to refer to non-limiting examples and/or variant embodiments discussed herein, and are not intended to indicate preference for one or more embodiments discussed herein compared to one or more other embodiments.

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

Recitation of ranges of values herein are merely intended to serve as a shorthand method of referring individually to each separate value falling within the range, unless otherwise indicated herein, and each separate value is incorporated into the specification as if it were individually recited herein. For example, if the range 10 to 15 is disclosed, then 11, 12, 13, and 14 are also disclosed.

A “portion” or “fragment” of a material or component as used herein refers to less than all (e.g., less than 100%) of the material or component or of a measurable value thereof. In some embodiments, a “portion” or “fragment” of a material or component refers to about 1%, 5%, 10%, 15%, 20%, 25%, 30%, 35%, 40%, 45%, 50%, 55%, 60%, 65%, 70%, 75%, 80%, 85%, 90%, 95%, 97%, 98%, or 99% of the material or component or of a measurable value of the material or component (e.g., a portion of the length, volume, weight, sequence, etc.).

The term “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

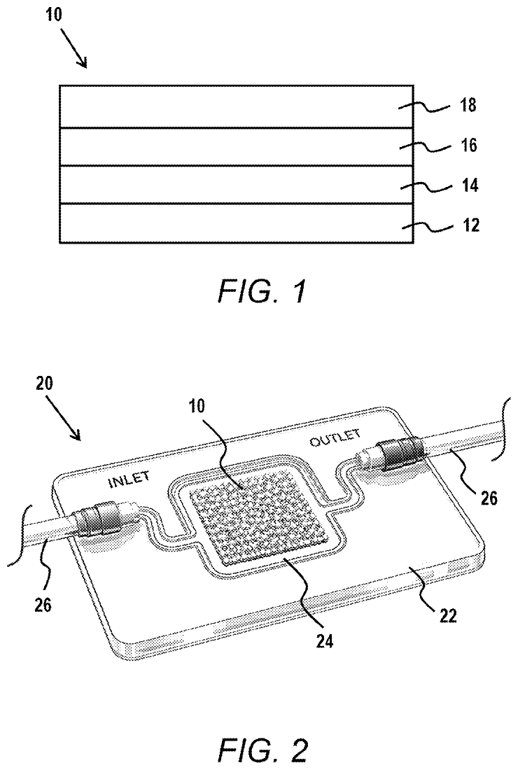

In some embodiments, the present disclosure provides a nanostructured substrate for optical and/or electrochemical analysis. As shown in FIG. 1, the nanostructured substrate 10 includes a substrate base layer 12 having at least a first surface, a hydrophobic coating 14 disposed over at least the first surface of the substrate base layer 12, and a metallic nanostructure layer 16 disposed over at least a portion of the hydrophobic coating 14. The metallic nanostructure layer 16 has a nominal thickness from about 3 nanometers to about 15 nanometers and includes a plurality of metallic nanostructures deposited at quasi-periodic intervals and separated by gaps, the metallic nanostructures having an average diameter from about 10 nanometers to about 100 nanometers.

The base material for the nanostructured substrate 10 is a substrate base layer 12 which is modified by the hydrophobic coating 14 and by the metallic nanostructure layer 16.

Suitable materials for use as the substrate base layer 12 include, but are not limited to, materials selected from the group consisting of a cellulosic web, glass, silica, quartz, polymers, mica, and metal. In some embodiments, the substrate base layer 12 comprises a cellulosic paper web, such a nitrocellulose paper.

The substrate base layer 12 is substantially two dimensional, having a length and a width which are much large than the thickness of the substrate base layer 12.

The substrate base layer 12 comprises at least a first surface and typically comprises a first surface and a second surface.

In some embodiments, the substrate base layer 12 may initially be provided in a length up to about 12 inches, for instance a length of about 1, 2, 3, 4, 5, 6, 7, 8, 9, 10, 11, or 12 inches. The substrate base layer may initially be provided in a width up to about 10 inches, for instance a length of about 1, 2, 3, 4, 5, 6, 7, 8, 9, or 10 inches. After completion, the substrate may later be divided into a plurality of sensors, with each sensor typically being on the order of about 5 mm by 5 mm. Thus, in some embodiments, the substrate may eventually be divided into over 1000 sensors, e.g., up to about 1500, 2000, 2500, or 2800 sensors.

A hydrophobic coating 14 is disposed over at least the first surface of the substrate base layer 12. In some embodiments, the hydrophobic coating 14 is disposed over at least 50%, at least 60%, at least 70%, at least 80%, or at least 90% of the first surface. In some embodiments, the hydrophobic coating 14 may also be disposed over at least a portion of the second surface.

The thickness of the hydrophobic coating 14 is typically from about 0.5 nanometers to about 100 microns and more preferably from about 0.5 nanometers to about 50 microns.

In some embodiments, the hydrophobic coating 14 comprises at least one hydrophobic agent selected from the group consisting of substituted or unsubstituted organosilanes, substituted or unsubstituted fluorosilanes, substituted or unsubstituted chlorosilanes, fatty acids, waxes, self-assembled monolayer-forming agents, and combinations thereof. In some embodiments, the hydrophobic coating 14 comprises substituted or unsubstituted fluorosilane. Examples of suitable flurosilanes may be selected from the group consisting of perfluorooctyltrichlorosilane, perfluorodecyltrichlorosilan, 1H,1H,2H,2H-perfluorooctyl-triethoxysilan, fluoroalkylsilanes, and mixtures thereof. In some embodiments, the hydrophobic coating 14 comprises perfluorooctyltrichlorosilane.

The hydrophobic coating 14 alters the surface properties of the substrate base layer material. The initial substrate 12 may be substantially hydrophilic, particularly when the substrate comprises a cellulosic web. Application of the hydrophobic coating substantially lowers the surface energy of the substrate first surface, leading to water resistance and beading.

This may be seen by measurement of the water contact angle on the substrate surface. Before application of the hydrophobic coating, the surface of a cellulosic substrate may have a water contact angle of less than 9 degrees and in some instances approaching 0 degrees. Following application of the hydrophobic coating, a water contact angle of at least 90 degrees is observed. In some embodiments, the water contact angle is at least 110 degrees, at least 120 degrees, at least 130 degrees, or at least 140 degrees.

A metallic nanostructure layer 16 is disposed over at least a portion of the hydrophobic coating 14. In some embodiments, the metallic nanostructure layer 16 is disposed over at least 50%, at least 60%, at least 70%, at least 80%, or at least 90% of the hydrophobic coating 14.

In some embodiments, the metallic nanostructure layer 16 comprises at least one metal selected from the group consisting of silver, gold, titanium, iron, chromium, nickel, aluminum, platinum, copper, and combinations thereof. In some embodiments, the metallic nanostructure layer comprises silver.

The metallic nanostructure layer 16 is generally applied over the hydrophobic layer 14 by a vapor deposition process, such as physical vapor deposition (PVD) or chemical vapor deposition (CVD). The metallic nanostructure layer 16 is generally applied to produce a layer having a nominal thickness (based on the deposition rate) from about 3 nanometers to about 15 nanometers. In some embodiments, the metallic nanostructure layer 16 has a nominal thickness from about 5 nanometers to about 12 nanometers, or about 5 nanometers to about 10 nanometers.

The metallic nanostructure layer 16 is not formed as a continuous layer over the entire surface of the hydrophobic coating 14. Instead, the metallic nanostructure layer 16 is made up of plurality of metallic nanostructures deposited at quasi-periodic intervals and separated by gaps. In some embodiments, these gaps may function as hot spots for certain analytical techniques, such as surface-enhanced Raman spectroscopy.

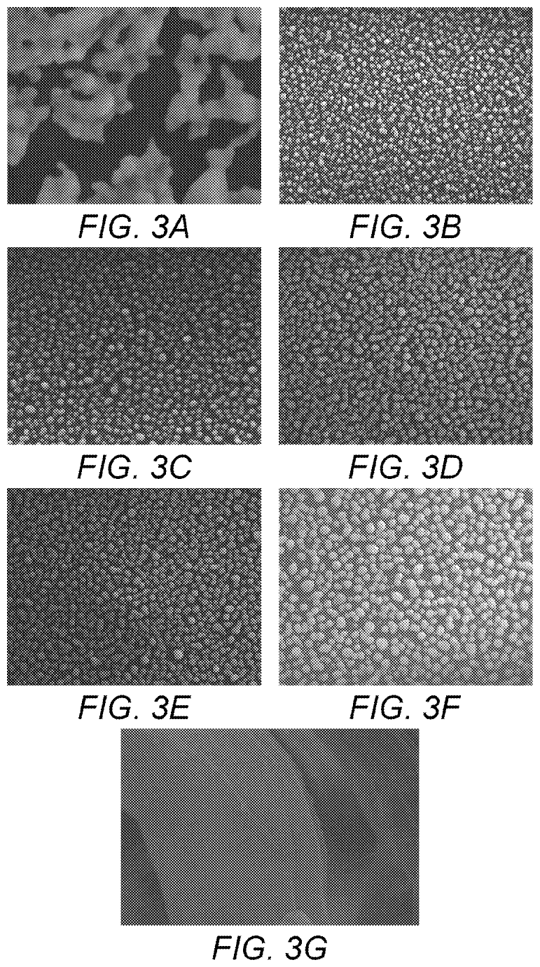

Examples of such metallic nanostructures are illustrated in the scanning electron micrographs presented as FIGS. 3A-3F. In FIG. 3A, the nominal thickness of the metallic nanostructure layer 16 is 3 nanometers. In FIGS. 3B-3F, the nominal thicknesses are 5 nanometers, 7 nanometers, 10 nanometers, 12 nanometers, and 15 nanometers, respectively. FIG. 3G is a micrograph of an uncoated paper used as a control sample.

As used herein, “quasi-periodic” intervals means that the nanaostructures are deposited in a generally repeating pattern; however, the spatial intervals between adjacent pairs of nanostructures are not exactly equal. Rather, the spatial interval between any adjacent pair of nanostructures may vary by up to about 20 nanometers from the average spatial intervals between adjacent pairs of nanostructures, wherein the spatial interval is measured from the center of one nanostructure to the center of the next adjacent nanostructure.

The metallic nanostructures typically have an average diameter from about 10 nanometers to about 100 nanometers. In some embodiments, the metallic nanostructures have an average diameter from about 15 nanometers to about 50 nanometers. In some embodiments, the metallic nanostructures have an average diameter from about 25 nanometers to about 40 nanometers. Moreover, the diameters of the metallic nanostructures is relatively uniform, with a polydispersity index which is less than about 0.25. In some embodiments, the diameters of the metallic nanostructures have a polydispersity index which is less than about 0.15.

The average height of the metallic nanostructures is typically from about 60 nanometers to about 100 nanometers. In some embodiments, the average height of the metallic nanostructures is typically from about 65 nanometers to about 90 nanometers.

The gaps formed between adjacent metallic nanostructures typically have a width of about 2 nanometers to about 40 nanometers. In some embodiments, the gaps formed between adjacent metallic nanostructures have a width of about 2 nanometers to about 10 nanometers.

In some embodiments, the nanostructured substrate 10 further comprises an optional functionalizing layer 18 disposed over the hydrophobic coating 14 and the metallic nanostructure layer 16. This functionalizing layer 18 may comprise an organosilane coupling agent, such as (3-Aminopropyl)triethoxysilane (APTES) or (3-Glycidyloxypropyl)trimethoxysilane (GPTMS). The functionalizing layer serves to improve bonding between the nanosurfaced substrate and organic molecules such as analytes. For example, APTES provides amine groups for antibody/ligand conjugation, and GPTMS provides epoxy groups for biomolecule attachment. Thus, the substrate may be functionalized for use with antibodies, aptamers, DNA/RNA, and other analyte-specific binding agents, transforming into a targeted diagnostic device, e.g., enabling disease-specific diagnostics.

The nanosurfaced substrate is suitable for use in the detection and measurement of a wide variety of analytes. In some embodiments, the nanostructured substrate may be used for medical diagnostics, such as disease biomarker detection, therapeutic drug monitoring, point-of-care testing, extracellular vesicle analysis, protein conformation studies, metabolite sensing, hormone level monitoring, nucleic acid detection, cell surface marker analysis, and immune response monitoring.

In some embodiments, the nanostructured substrate may be used for food safety testing, such as pathogen detection, toxin screening, allergen testing, authenticity verification, freshness monitoring, pesticide residue analysis, antibiotic detection, quality control, shelf-life prediction, and contamination screening.

In some embodiments, the nanostructured substrate may be used for environmental monitoring, such as water quality analysis, air pollution detection, soil contamination testing, heavy metal sensing, microplastic detection, chemical spill monitoring, pesticide runoff analysis, industrial emission control, groundwater testing, and marine environment monitoring.

In some embodiments, the nanostructured substrate may be used for security applications, such as explosive detection, chemical threat sensing, biological agent screening, drug detection, forensic analysis, border security screening, mail screening, currency authentication, document verification, and personal protective equipment testing.

In some embodiments, the nanostructured substrate may be used for industrial applications, such as process control monitoring, quality assurance, raw material testing, product authentication, reaction monitoring, catalyst efficiency testing, cleaning validation, surface contamination analysis, wear debris monitoring, and lubricant analysis.

In a second aspect, the present disclosure provides a method for making a nanostructured substrate for spectroscopic analysis. The method comprises a step of providing a substrate base layer 12 having at least a first surface. As discussed above, the substrate base layer 12 comprises materials selected from the group consisting of a cellulosic web, glass, silica, quartz, polymers, mica, and metal. In some embodiments, the substrate base layer 12 preferably comprises a cellulosic paper web, such a nitrocellulose paper.

A hydrophobic coating 14 is then formed over at least the first surface of the substrate base layer 12. In some embodiments, the hydrophobic coating 14 is selected from the group consisting of substituted or unsubstituted organosilanes, substituted or unsubstituted fluorosilanes, substituted or unsubstituted chlorosilanes, fatty acids, waxes, self-assembled monolayer-forming agents, and combinations thereof. In some embodiments, the hydrophobic coating 14 comprises substituted or unsubstituted fluorosilane. Examples of suitable flurosilanes include, but are not limited to the group consisting of perfluorooctyltrichlorosilane, perfluorodecyltrichlorosilan, 1H,1H,2H,2H-perfluorooctyl-triethoxysilan, fluoroalkylsilanes, and mixtures thereof. In some embodiments, the hydrophobic coating 14 comprises perfluorooctyltrichlorosilane.

The hydrophobic coating 14 may be applied over the first surface as a liquid composition and then cured to form a solid hydrophobic coating. The coating is typically allowed to cure for a time period of at least 4 hours up to 48 hours and at room temperature.

The metallic nanostructure layer 16 is then formed by vapor deposition over at least a portion of the hydrophobic coating 14. In some embodiments, the metallic nanostructure layer is formed by physical vapor deposition. In some embodiments, the metallic nanostructure layer is formed by chemical vapor deposition.

For physical vapor deposition, the deposition process is typically carried out in a pressure vessel at a temperature from about 20° C. to about 25° C. and under a high vacuum, with an absolute pressure of no more than about 10⁻⁶ Torr. In some embodiments, the pressure vessel is purged with nitrogen before being drawn into vacuum.

For chemical vapor deposition, the deposition process is typically carried out in a pressure vessel at a temperature from about 20° C. to about 25° C. and under a high vacuum, with an absolute pressure of no more than about 10⁻⁴ Torr.

As noted above, a functionalizing layer 18 may be optionally applied over the hydrophobic coating and the metallic nanostructure layer in a further processing step. The functionalizing layer may for instance comprise an organosilane coupling agent, such as (3-Aminopropyl)triethoxysilane (APTES) or (3-Glycidyloxypropyl)trimethoxysilane (GPTMS).

In a second aspect, the present disclosure provides a surface for chemical analysis. The surface may for example function as a chip for analyzing microfluidic samples using one or more spectroscopic techniques.

As seen in FIG. 2, the surface 20 comprises a polymer enclosure 22. The surface 20 also comprises at least one sample well 24, disposed within the polymer enclosure 22. In some embodiments the surface 20 may comprise a plurality of sample wells. A nanostructured substrate 10, as described above, is disposed within the polymer enclosure 22, typically in area of the sample well(s) 24.

In some embodiments, the polymer enclosure also comprises a lateral flow pathway 26 for inflow and outflow of material to be analyzed.

In some embodiments, the surface is adapted for use in at least one analytical technique selected from the group consisting of surface-enhanced Raman spectroscopy (SERS), localized surface plasmon resonance (LSPR), surface-enhanced infrared absorption spectroscopy (SEIRAS), electrochemical sensing, fluorescence-based detection, and colorimetric detection. In some embodiments, the surface is adapted for use with surface-enhanced Raman spectroscopy (SERS).

When used in analytical techniques such as SERS, it has been found that the nanostructured substrates provide improved sensitivity in the detection of analytes. Without being bound by theory, it is believed that the gaps between the metallic nanostructures function as electromagnetic hot spots which improve the analytical sensitivity. More specifically it is believed that high hydrophobicity of the substrate surface causes droplets of the analyte composition to contract and accumulate within the gaps between the metallic nanostructures. In this manner, the analyte material is effectively concentrated within the gaps leading to substantially improved detection sensitivity.

This improvement in detection sensitivity is particularly advantageous when analyzing environmental or biological samples where target analyte concentrations may be in the micromolar (10⁻⁶M) to picomolar (10⁻⁹M) range. In some embodiments, the metallic nanostructures of the present invention allow for detection of analysts at concentrations as low as 2 pM.

In still another aspect, the present disclosure provides an antimicrobial material. The antimicrobial material comprises a substrate base layer having at least a first surface, a hydrophobic coating disposed over at least the first surface of the substrate base layer, and a metallic nanostructure layer disposed over at least a portion of the hydrophobic coating wherein the metallic nanostructure layer imparts antimicrobial activity to the substrate.

In some embodiments, the substrate base layer comprises a material selected from the group consisting of a cellulosic web, glass, silica, quartz, polymers, mica, and metal.

In some embodiments, the metallic nanostructure layer comprises at least one metal selected from the group consisting of silver, gold, titanium, iron, chromium, nickel, aluminum, platinum, copper, and combinations thereof. In some embodiments, the metallic nanostructure layer comprises silver.

In some embodiments, the antimicrobial material inhibits growth of bacteria, fungi, viruses, or combinations thereof.

In some embodiments, the antimicrobial material is adapted for use as a food packaging material, medical packaging material, wound dressing, or surface coating.

Having described the present invention, the same will be explained in greater detail in the following examples, which are included herein for illustration purposes only, and which are not intended to be limiting to the invention.

### Examples

As described in this example, a series of nanostructured substrates were prepared and analyzed using surface-enhanced Raman spectroscopy (SERS), scanning electron microscopy (SEM), and atomic force microscopy (AFM).

### Materials

Perfluorooctyltrichlorosilane (97%) was purchased from Thermo Fisher. Whatman no. 5 filter paper and rhodamine B (RhB) were obtained from Millipore Sigma. All materials were used without further purification.

### Substrate Fabrication

Filter paper substrates were treated with fluorosilane in a batch chamber for 24 hours at room temperature to create hydrophobic surfaces. Silver was deposited using physical vapor deposition (Lesker PVD75 E-Beam/Thermal Evaporator) at nominal thicknesses (3, 5, 7, 10, 12, 15 nm) under high vacuum (≈10⁻⁸ Torr) to form nanostructures on the hydrophobic surfaces. Deposition rate was maintained at 14 mA, 0.1 Å/s and monitored using quartz crystal microbalance.

### SERS Measurements

For SERS analysis, RhB solutions at various concentrations were applied to the nanostructured substrates with 5 and 7 nm thicknesses and allowed to dry for about 2 hours at room temperature before measurement. Raman spectra were acquired using a WiTec confocal Raman microscope equipped with a 532 nm laser excitation source. Measurements were performed at 0.05 mW laser power to prevent sample damage while maintaining sufficient signal intensity. The SERS enhancement factor (EF) of the nanoprobes was assessed by calculating the analytical EF (AEF) using the following equation:

$$AEF = \frac{{C}_{Raman} {I}_{SERS}}{{I}_{Raman} {C}_{SERS}}$$

where I_{SERS} and I_{Raman} represent the peak intensities obtained from Ag-deposited treated substrate and Ag-deposited control substrate, respectively, while C_{SERS} and C_{Raman} denote the lowest detectable RhB concentrations in SERS substrate and control substrate, respectively.

### Substrate Characterization

Scanning electron microscopy (SEM) and elemental analysis were performed with a JEOL JSM-IT800HL FESEM and Oxford Instruments Unity BEX hybrid BSE/X-ray detector. High-resolution SEM images and X-ray spectra were acquired at 10 keV with 10 mm working distance. AC mode Atomic Force Microscopy (AFM) was performed with an Oxford Instruments Asylum MFP-3D. Nominal cantilever and tip parameters were 300 kHz, 40 N/m, and ~10 nm diameter. Image analysis was performed using ImageJ (SEM) and Gwyddion (AFM) software and graphs were plotted with OriginPro 9.5.

### Data Analysis

Particle size distributions were determined from SEM images analyzing. Polydispersity index (PDI) was calculated as standard deviation per mean diameter. Enhancement factor was determined comparing SERS intensity to normal Raman on control substrates. Limits of detection (LOD) was calculated as 3σ/slope, where σ is standard deviation of four blank measurements.

### Results-Nanostructure Formation

Systematic investigation across 3-15 nm silver nanostructure depositions revealed critical structure-performance relationships. At 3 nm, the deposited silver exhibited island growth rather than uniform nanostructure distribution (FIG. 3A). On the hydrophobic surface, insufficient silver atoms initially reached the substrate to establish adequate nucleation sites for individual particle formation. Consequently, subsequently deposited silver preferentially migrated to these limited nucleation sites, forming large aggregated clusters through layer-by-layer island growth (Volmer-Weber mechanism). Additionally, at such ultra-thin depositions, surface heterogeneities (e.g., localized defects or pores) may preferentially serve as nucleation sites, further concentrating silver deposition into discrete islands. It should be noted that the specific island formation behavior at very thin depositions may be influenced by PVD parameters such as deposition rate and chamber conditions, which can affect nucleation kinetics. This resulted in bright, prominent aggregates with significant bare substrate areas between them.

The 5 nm silver deposition demonstrated optimal uniformity with nanostructures having an average diameter of 29±4 nm and the highest density of nanostructures (FIG. 3B). A PDI of 0.13 was measured indicating that 68% of particles fall within ±4 nm of the mean size, ensuring uniform electromagnetic enhancement across the substrate. This uniformity is beneficial for quantitative SERS, as enhancement factors (EFs) scale non-linearly with particle size, small morphological variations can cause order-of-magnitude differences in signal intensity between adjacent regions. The 5 nm thickness provides sufficient material overcoming hydrophobic barriers while preventing excessive Ostwald ripening.

At 7 nm, despite similar average diameters (29±5 nm), the system showed 69% increased polydispersity (PDI=0.22) and reduced density (FIG. 3C). With a PDI of 0.22, approximately 32% of nanostructures deviate significantly from the mean size, creating spatially heterogeneous enhancement. This greater heterogeneity implies that the additional silver content begins to disrupt the delicate balance of controlled nucleation established at the 5 nm thickness. The growth mechanism shifts from nucleation-dominated to growth-dominated processes due to the excess material availability. This occurs when existing particles preferentially capture more silver atoms instead of creating new nucleation sites. Nonetheless, the 7 nm thickness nanostructures are still suitable for enhancement of SERS.

While still suitable for enhancement of SERS, thicker silver depositions having nominal thicknesses of 10⁻¹⁵ nm (FIGS. 3D-3F) displayed progressive coalescence. At 10 nm, the silver nanostructures reached an average diameter of 45±7 nm (57% increase), while a 15 nm nominal thickness showed the largest nanostructure diameters (57±13 nm) with 70% reduced density versus optimal conditions. The systematic progression from 3 nm to 15 nm thickness reveals morphological evolution from optimal controlled nucleation (5 nm), through transitional growth-dominated regimes (7-10 nm), to eventual loss of size control and reduced particle density at excessive thicknesses (12-15 nm). This transition from island growth to individual particle formation represents a thickness-dependent nucleation phenomenon. While the specific threshold thickness may depend on deposition parameters, substrate surface characteristics, PVD equipment characteristics, and kinetic factors during ultra-thin film growth, these results demonstrate that uniform nanostructure coverage requires sufficient initial material to overcome the nucleation barriers presented by the hydrophobic surface. This progression demonstrates the critical importance of precise thickness control in maintaining the delicate balance between sufficient material availability and controlled nanostructure formation. For comparison, control substrates without fluorosilane treatment showed a significantly different morphology with irregular silver film formation rather than discrete nanostructures (FIG. 3G).

### Results—Three Dimensional Architecture and Elemental Composition.

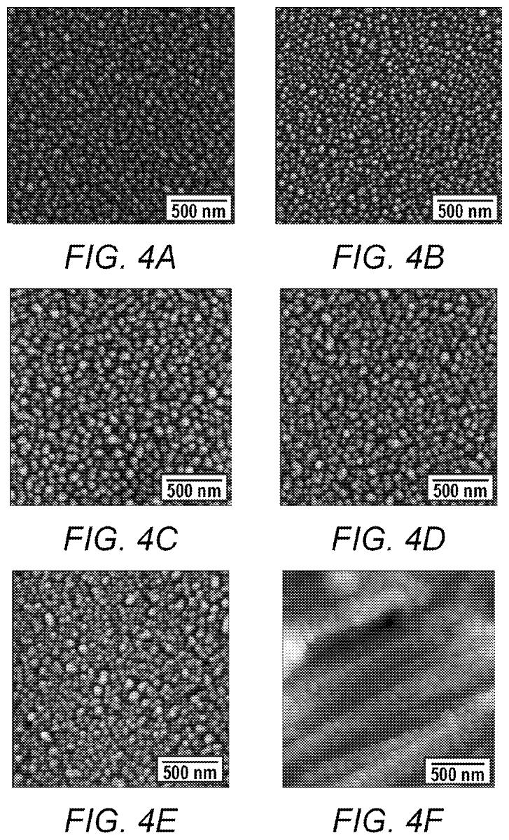

Atomic force micrographs of the nanostructures are presented as FIGS. 4A-4E. In FIG. 4A, the nominal thickness of the metallic nanostructure layer is 5 nanometers. In FIGS. 4B-4E, the nominal thicknesses are 7 nanometers, 10 nanometers, 12 nanometers, and 15 nanometers, respectively. FIG. 4F is a micrograph of an uncoated paper used as a control sample.

The AFM topographical analysis revealed significant vertical amplification. For instance, silver deposited to a nominal thickness of 5 nm transforms into 66 nm height particles. This 13-fold amplification has important implications for SERS performance. Vertically extended particles create deep electromagnetic field gradients extending into the solution phase, increasing the effective sensing volume by over an order of magnitude compared to planar film geometries. The vertical architecture generates “lightning rod” effects at particle tips, producing intense field localization sufficient for single-molecule detection. The 10⁻²⁰ nm distance between adjacent nanostructures forms optical nanocavities where incident electromagnetic radiation becomes trapped and recirculates, further amplifying local field enhancement.

Elemental analysis showed silver content progression with increasing nominal thickness from 8.1% (5 nm) to 31.1% (15 nm). Despite only 43% more deposition, silver increased 2.5 times between 7 and 10 nm, suggesting a fundamental shift where incoming atoms are efficiently captured by sufficient particle density. Fluorine signals remained constant (11.2-11.5%), indicating surface modification stability despite energetic atom exposure. Backscattered Electron and X-ray (BEX) elemental mapping confirmed uniform distribution of silver, fluorine, and silicon across all deposition thicknesses, with no evidence of elemental segregation or localized depletion.

The ratios of fluorine to silver reveal that at 5 nm (F/Ag=1.38), fluorine dominates while maintaining hydrophobicity; at 15 nm (F/Ag=0.37), silver dominates but maintains hydrophobicity) (CA>110°. It should be noted that BEX quantification on topographically complex surfaces is subject to artifacts from variable interaction volumes and X-ray shadowing/reabsorption by surface features, particularly at higher NP densities. Therefore, these values represent semi-quantitative trends rather than absolute surface composition. Nonetheless, this architectural configuration creates dual-function surfaces, with fluorinated areas between particles maintaining their hydrophobic nature for analyte concentration and silver islands offering plasmonic enhancement. In fact, the resulting topography essentially engineers surfaces where “valleys” repel aqueous solutions and “peaks” enhance Raman signals, creating synergistic effects that amplify sensitivity beyond individual component contributions.

### SERS Performance and Analytical Metrics

SERS performance using Rhodamine B (RhB) demonstrated exceptional sensitivity. The 5 nm substrate showed peak intensities from 201 at 10⁻⁹ M concentration to 19,793 at 5×10⁻⁵ M concentration, while maintaining linearity across four orders of magnitude (R²=0.98). This linear dynamic range spanning four orders of magnitude of concentration is essential for practical analytical applications, where environmental or biological samples may contain target analytes at concentrations varying from 10⁻¹² M to 10⁻⁶ M. Through controlled deposition, a 2 μM concentration detection limit provides superior reproducibility while surpassing many chemically synthesized substrates. Further, an enhancement factor of 106 demonstrates strong enhancement suitable for ultrasensitive detection. This enhancement corresponds to sensitivity improvements from μM to pM concentration ranges. For clinical diagnostics, this sensitivity range encompasses disease biomarker concentrations relevant for early-stage disease detection.

The 7 nm substrate exhibited a 2.3-fold decrease in performance, with a peak intensity range of 43 to 8,525. A reduction in enhancement factor to 105 was also observed, despite only 2 nm additional deposition. This demonstrates the extreme sensitivity of SERS performance to morphological parameters. This degradation results from particle coalescence reducing the density of sub-10 nm hot spots between adjacent AgNP where most electromagnetic enhancement occurs.

Temporal stability of the nanostructured substrates was also evaluated and revealed distinct requirements: more than 95% of the nanostructure was retained after almost one month under nitrogen, but a complete loss was observed after 2 days exposure to ambient conditions. The rapid ambient degradation results from the high surface-to-volume ratio of 29 nm nanostructures, which makes them highly susceptible to oxidation. Atmospheric oxygen forms nanometer-scale Ag₂O surface layers that completely decouple the plasmonic resonance by converting metallic silver to its oxide, effectively “switching off” the optical nanoantenna function. This suggests protective coatings (silica shells, thiol monolayers) and/or maintaining under nitrogen or oxygen scavengers could extend shelf life to months.

The single-step PVD fabrication offers reproducibility advantages over wet chemical synthesis. While the enhancement factor is moderate compared to some advanced architectures, it's achieved through straightforward modification without complex assembly.

The above-disclosed subject matter is to be considered illustrative, and not restrictive, and the appended claims are intended to cover all such modifications, enhancements, and other embodiments, which fall within the scope of the disclosure. Thus, to the maximum extent allowed by law, the scope is to be determined by the broadest permissible interpretation of the following claims and their equivalents, and shall not be restricted or limited by the foregoing detailed description.

We claim:

1. A nanostructured substrate for optical and/or electrochemical analysis comprising:
a substrate base layer having at least a first surface;
a hydrophobic coating disposed over at least the first surface of the substrate base layer; and
a metallic nanostructure layer disposed over at least a portion of the hydrophobic coating,
wherein the metallic nanostructure layer has a nominal thickness from about 3 nanometers to about 15 nanometers, and
wherein the metallic nanostructure layer comprises a plurality of metallic nanostructures deposited at quasi-periodic intervals and separated by gaps, the metallic nanostructures having an average diameter from about 10 nanometers to about 100 nanometers.

2. The nanostructured substrate of claim 1, wherein the substrate base layer comprises a material selected from the group consisting of a cellulosic web, glass, silica, quartz, polymers, mica, and metal.

3. The nanostructured substrate of claim 1, wherein the hydrophobic coating comprises at least one hydrophobic agent selected from the group consisting of substituted or unsubstituted organosilanes, substituted or unsubstituted fluorosilanes, substituted or unsubstituted chlorosilanes, fatty acids, waxes, self-assembled monolayer-forming agents, and combinations thereof.

4. The nanostructured substrate of claim 1, wherein the metallic nanostructure layer comprises at least one metal selected from the group consisting of silver, gold, titanium, iron, chromium, nickel, aluminum, platinum, copper, and combinations thereof.

5. The nanostructured substrate of claim 1, wherein the metallic nanostructures have a polydispersity index of less than about 0.25.

6. The nanostructured substrate of claim 1, wherein the first surface of the substrate, after the hydrophobic coating is applied, exhibits a water contact angle of at least 90 degrees.

7. The nanostructured substrate of claim 1, wherein the nanostructured substrate further comprises a functionalizing layer disposed over the hydrophobic coating and the metallic nanostructure layer.

8. A surface for chemical analysis comprising:
a polymer enclosure;
at least one sample well, disposed within the polymer enclosure; and
a nanostructured substrate in accordance with claim 1 disposed within the polymer enclosure.

9. The surface of claim 8, wherein the surface is adapted for use in at least one analytical technique selected from the group consisting of surface-enhanced Raman spectroscopy (SERS), localized surface plasmon resonance (LSPR), surface-enhanced infrared absorption spectroscopy (SEIRAS), electrochemical sensing, fluorescence-based detection, and colorimetric detection.

10. A method for making a nanostructured substrate for optical and/or electrochemical analysis, comprising:
providing a substrate base layer having at least a first surface;
forming a hydrophobic coating disposed over at least the first surface of the substrate base layer; and
forming a metallic nanostructure layer by vapor deposition, disposed over at least a portion of the hydrophobic coating;
wherein the metallic nanostructure layer has a nominal thickness from about 3 nanometers to about 10 nanometers; and
wherein the metallic nanostructure layer comprises a plurality of metallic nanostructures deposited at quasi-periodic intervals and separated by gaps, the metallic nanostructures having an average diameter from about 10 nanometers to about 100 nanometers.

11. The method of claim 10, wherein the substrate base layer comprises a material selected from the group consisting of a cellulosic web, glass, silica, quartz, polymers, mica, and metal.

12. The method of claim 10, wherein the hydrophobic coating comprises at least one hydrophobic agent selected from the group consisting of substituted or unsubstituted organosilanes, substituted or unsubstituted fluorosilanes, substituted or unsubstituted chlorosilanes, fatty acids, waxes, self-assembled monolayer-forming agents, and combinations thereof.

13. The method of claim 10, wherein the metallic nanostructure layer comprises at least one metal selected from the group consisting of silver, gold, titanium, iron, chromium, nickel, aluminum, platinum, copper, and mixtures thereof.

14. The method of claim 10, wherein the metallic nanostructures have a polydispersity index of less than about 0.25.

15. The method of claim 10, wherein the first surface of the substrate, after the hydrophobic coating is applied, exhibits a water contact angle of at least 90 degrees.

16. The method of claim 10, wherein the nanostructured substrate further comprises a functionalizing layer disposed over the hydrophobic coating and the metallic nanostructure layer.

17. An antimicrobial material comprising:
a substrate base layer having at least a first surface;
a hydrophobic coating disposed over at least the first surface of the substrate; and
a metallic nanostructure layer disposed over at least a portion of the hydrophobic coating,
wherein the metallic nanostructure layer imparts antimicrobial activity to the substrate.

18. The antimicrobial material of claim 17, wherein the substrate base layer comprises a material selected from the group consisting of a cellulosic web, glass, silica, quartz, polymers, mica, and metal.

19. The antimicrobial material of claim 17, wherein the metallic nanostructure layer comprises at least one metal selected from the group consisting of silver, gold, titanium, iron, chromium, nickel, aluminum, platinum, copper, and combinations thereof.

20. The antimicrobial material of claim 17, wherein the antimicrobial material inhibits growth of bacteria, fungi, viruses, or combinations thereof.

21. The antimicrobial material of claim 17, wherein the antimicrobial material is adapted for use as a food packaging material, medical packaging material, wound dressing, or surface coating.
